(19) United States
(12) Patent Application Publication
(10) Pub. No.: US 2007/0221490 A1
(43) Pub. Date: Sep. 27, 2007

(54) Keyboard and method for applying in-mold decoration technology to manufacture the keyboard with more key height and less key spacing

(75) Inventors: Chih-Feng Huang, Hsichih (TW); Jen-Min Huang, Hsichih (TW)

Correspondence Address: BRUCE H. TROXELL, 5205 LEESBURG PIKE, SUITE 1404, FALLS CHURCH, VA, 22041, US

(73) Assignee: WISTRON CORP.

(21) Appl. No.: 11/647,391

(22) Filed: Dec. 29, 2006

(30) Foreign Application Priority Data
Mar. 23, 2006 (TW) 095110141

(51) Int. Cl. H01H 13/14; B28B 11/06

(52) U.S. Cl. 200/520; 264/131

(57) ABSTRACT

A keyboard and a method of applying in-mold decoration and ejaculation technology to manufacture the keyboard with more key height and less key spacing relates to a method of making a plastic film which includes a plurality of protruding portions, and cutting a plurality of protruding granules, and then applying the bottom base of the plurality of granules to integrate an elastic material layer to manufacture a keyboard; The gap between a plurality of keyboard's protruding portions is less than the protruding portions of the plastic film.

### BACKGROUND OF THE INVENTION

1. Field of the Invention:

The present invention relates to a keyboard, especially as it relates to a method of applying in-mold decoration technology to manufacture a keyboard.

2. Brief Description of Related Art:

Portable electronic products include PDAs, or smart phones. Most are equipped with a pocket-sized keyboards for users to control and access data. The pocket-sized keyboard for applying in-mold decoration and ejaculation technology is to provide a variety of numerals and symbols on the film of the key's surface. There is no need to execute multiple printing after the keys are manufactured, therefore it is convenient to manufacture a keyboard with diverse colors for numerals and symbols printing.

There are a number of patents relating to keys of compound keyboards, such as Taiwan Pat. No. 465792, No. 465795, No. 470208 and No. 490069. The Taiwan Pat. No. 490069 disclosed keys of compound keyboard, wherein there is reversed designated number of letters, symbols and patterns and printed on the one side of the polyester film. All the keys are placed into the mold to make a press pattern and manufacture a plurality of protruding portions on the surface of polyester film, and to integrate a thermal flexible plastic into the interior of the protruding portion for polyester film. Further, to provide a proper keyboard with tactile impression of resilience and key-press.

Referring to FIG. 1, the required colors of numerals, symbols are usually printed on the polycarbonate film 10, and uses the vacuum pump mold to apply polycarbonate film 10 to form a plurality of protruding portions 11 which act as a press key. Furthermore, the protruding portions 11 are placed into the mold. The interior of the protruding portions 11 are filled with polycarbonate material, and then apply the punch press and cut process to the polycarbonate film 10 to form the exterior of the keyboard.

Technology shows a small and thin for modern electronic products such as numerous keys integrated into a certain size, or less keys integrated, but do raise the height for the key to satisfy a consumer's tactile impression. When applying the vacuum extraction method to form a polycarbonate mold into a plurality of protruding portions 11 as shown in FIG. 1. The height of B of the protruding portions 11 is related to the spacing A of the protruding portions 11. Generally, the regular ratio is B:A=l:l and the maximum ratio is B:A=l:0.8. The maximum height for B is 4 mm. The upper part of the polycarbonate film 10 can cause a crack if the height of B is too high. If we set the height B of the protruding portions 11 for 3 mm, the required spacing of A is 2.4 mm. But for a small keyboard such as PDA or smart phone, the key's spacing is about 1.5-1.8 mm, so we only make a key of about 1.9-2.3 mm. Therefore, it is impossible to apply current in-mold decoration and ejaculation technology to manufacture a keyboard with more key height and less key spacing.

### SUMMARY OF THE INVENTION

Therefore, the invention is proposed in order for applying an in-mold decoration technology to manufacture the keyboard with more key height and less key spacing.

The primary object of the present invention is to provide a keyboard and a method of applying in-mold decoration and ejaculation technology to manufacture the keyboard with more key height and less key spacing in a definite space.

Another object of the present invention is to provide a keyboard and a method of applying an in-mold decoration and ejaculation technology to manufacture the keyboard with more key height and less key spacing in a definite space to satisfy the consumer's demands.

Accordingly, the method of applying an in-mold decoration and ejaculation technology to manufacture the keyboard with more key height and less key spacing, comprising the steps of
(1) applying a plastic film which has a plurality of protruding portions placed into a cutting mold and cutting a plurality of protruding granules, wherein an in-mold decoration and ejaculation technology are applied to the plastic film. The interior of the protruding portions are filled with plastic material, and the gap between the protruding portions has the first spacing;
(2) applying the protruding granules placed into a plurality of grooves which are within a union mold, a second spacing between the grooves are provided, wherein the second spacing is less than the first spacing;
(3) applying the bottom base of the protruding granules is integrated into an elastic material layer, the spacing between the protruding granules have the second spacing, and applying the elastic material layer integrated into the protruding granules to manufacture a keyboard with more key height and less key spacing.

The step (3) further includes cutting the elastic material to manufacture the keyboard.

The plastic film is a polycarbonate resin film; the plastic material is a polycarbonate resin material; the elastic material layer is a rubber layer.

The step (3) further includes coating an ultraviolet (UV) hardenable resin to the bottom base of the protruding granules and integrating into the elastic material layer, and then curing the UV hardenable resin utilizing UV ray. Further, the elastic material layer is to integrate the protruding granules; or applying a glutinous stuff to adhesive the elastic material layer and the protruding granule.

A method for manufacturing the plastic film with the protruding portions comprising the steps of:
(a) applying an in-mold decoration and ejaculation technology to manufacture a plastic film, the plastic film includes a plurality of protruding portions, and the gap between the protruding portions has the first spacing;
(b) applying the plastic film placed into an ejaculation mold. In the ejaculation mold, the plastic material is filled in the interior of the protruding portions of the plastic film.

A keyboard which was manufactured by the above-mentioned method for applying an in-mold decoration technology to manufacture a keyboard with more key height and less key spacing, includes an elastic material layer to integrate a plurality of protruding granules, the surface of the protruding granules is a plastic film; the interior of the protruding granules are filled with the plastic material; wherein the plastic film is a polycarbonate resin film, the plastic material is a polycarbonate resin material, and the elastic material layer is a rubber layer; an UV hardenable resin is used to join the elastic material layer and the protruding granules.

### BRIEF DESCRIPTION OF THE DRAWINGS

The present invention can be more fully understood by reference to the following description and accompanying drawings, in which:

FIG. 1 is a schematic diagram, showing a prior art of applying an in-mold decoration and ejaculation technology to a plurality of protruding polycarbonate film.

FIG. 2A is schematic diagram illustrating the first step according to the present invention.

FIG. 2B is schematic diagram illustrating the second step according to the present invention.

FIG. 2C is schematic diagram illustrating the third step according to the present invention.

FIG. 2D is schematic diagram illustrating the fourth step according to the present invention.

FIG. 2E is schematic diagram illustrating the fifth step according to the present invention.

FIG. 2F is schematic diagram illustrating the sixth step according to the present invention.

FIG. 2G is schematic diagram illustrating the seventh step according to the present invention. and

FIG. 3 is a flow chart according to the present invention.

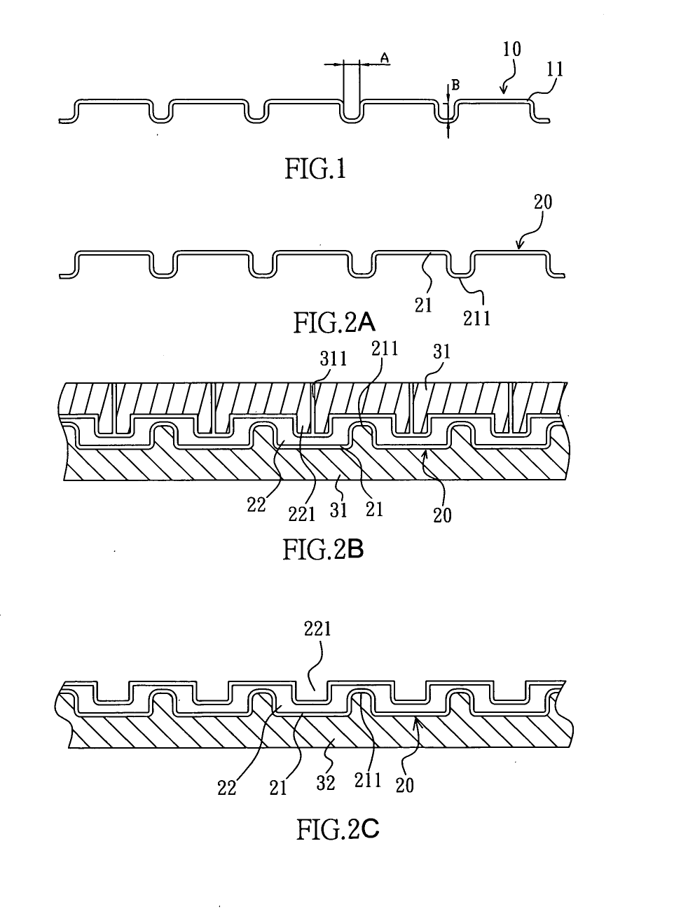

### DETAILED DESCRIPTION OF THE INVENTION

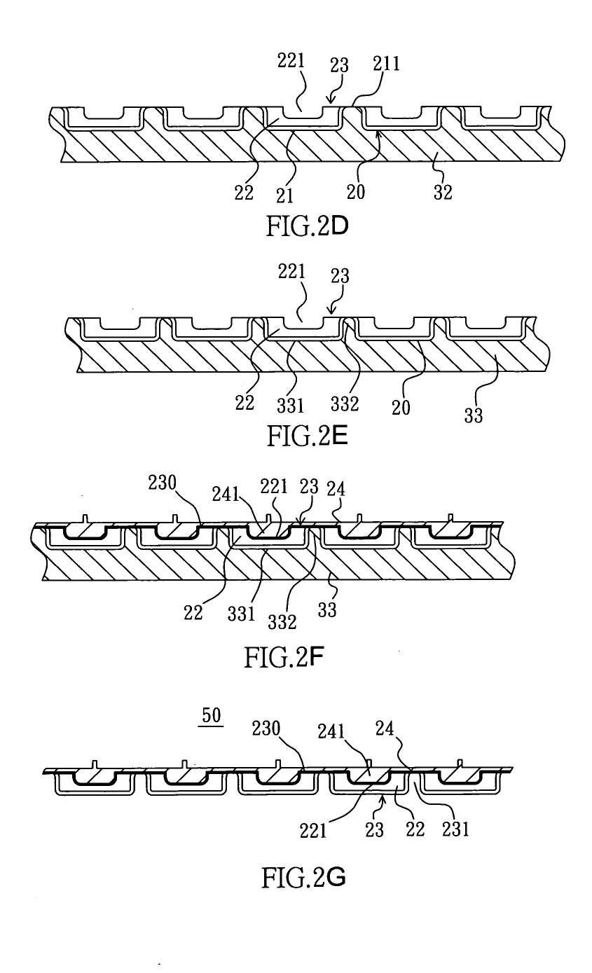

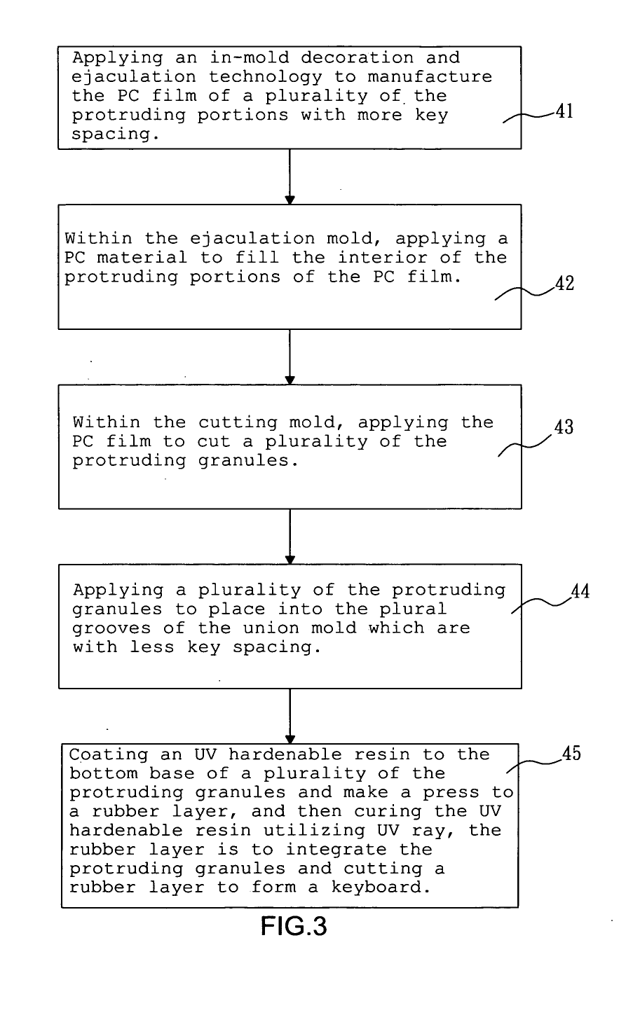

Referring to FIGS. 2A-2G and 3, shows a method of applying an in-mold decoration technology to manufacture a keyboard with more key height and less key spacing of a preferred embodiment of the present invention comprises the steps of:

(41) Applying in-mold decoration and ejaculation technology to manufacture a PC film 20; the PC film 20 includes a plurality of the protruding portions 21; the height of the protruding portions 21 corresponds with the required heights, a plurality of the protruding portions 21 include a first spacing 211 with comparative large spacing as shown in FIG. 2A.

(42) Placing the PC film 20 into an ejaculation mold 31. Within the ejaculation mold 31, the PC material 22 fills the interior of the protruding portion 21 of the PC film 20, and applies the PC material 22 which corresponds to each bottom base of the protruding portion 21 to form a groove 221 as shown in FIG. 2B.

(43) Applying the PC film 20 with the integrated PC material 22 and places it into the cutting mold 32 as shown in FIG. 2C. A plurality of protruding granules 23 are obtained using cutting, and the surface of the protruding granule 23 is PC film 20. The interior of the protruding granule 23 is filled with PC material 22 as shown in FIG. 2D.

(44) Applying a plurality of protruding granules 23 to place into a plurality of the grooves 331 of an union mold 33. A second spacing 332 between the grooves 331 has a less spacing as shown in FIG. 2E.

(45) Coating an UV hardenable resin 230 to the bottom base of a plurality of protruding granules 23, and integrates a rubber layer 24 such as the elastic material layer, the rubber layer 24 includes the protruding section 241 which fasten to the groove 221 of the protruding granules 23 as shown in FIG. 2F, and then curing the UV hardenable resin 230 utilizing UV ray, the rubber layer 24 is to joint with the protruding granules 23 with the smaller second spacing 231. A rubber layer 24 is cut to manufacture a required keyboard 50 as shown in FIG. 2G. If the size and exterior are in accordance with the requirement of the rubber layer 24, there is no need to cut the rubber layer 24.

The present invention relates to the PC film 20 comprised of a polyester film or other plastic material.

The present invention relates to a structure for integrating the protruding granules 23 and the rubber layer 24, Then applying a coating to the UV hardenable resin 230 on the jointed portions of the protruding granules 23 and the rubber layer 24, and placing a rubber layer 24 into the union mold to join the protruding granules 23, and curing the UV hardenable resin 230 utilizing UV ray, then integrating the protruding granules 23 and the rubber layer 24, also applying a structure with a glutinous stuff to join together, or applying a known jointed structure such as the groove 221, protruding portion 241.

The present invention relates to a method of applying in-mold decoration and ejaculation technology. It is feasible to manufacture a keyboard with more key height and less key spacing and also to satisfy the requirement of consumers.

While the invention has been described with referencing to a preferred embodiment thereof, it is to be understood that modifications or variations may be easily made without departing from the spirit of this invention, which is defined by the appended claims.

What is claimed is:

1. A method for applying an in-mold decoration technology to manufacture a keyboard with more key height and less key spacing, which comprises the steps of:
(1) applying a plastic film which has a plurality of protruding portions placed into a cutting mold and cutting a plurality of protruding granules, wherein an in-mold decoration and ejaculation technology are applied to a plurality of the protruding plastic film; the interior of a plurality of protruding portions are filled with plastic material, and the gaps between a plurality of protruding portions has a first spacing;
(2) applying a plurality of the protruding granules placed into a plurality of grooves which are within a union mold, a second spacing between a plurality of grooves are provided, wherein the second spacing is less than the first spacing; and
(3) applying the bottom base of a plurality of the protruding granules is integrated into an elastic material layer, the spacing between a plurality of the protruding granules have the second spacing, and applying the elastic material layer integrated into a plurality of protruding granules to manufacture a keyboard with more key height and less key spacing.

2. The method for applying an in-mold decoration technology to manufacture a keyboard with more key height and less key spacing according to claim 1, wherein the step (3) further includes cutting the elastic material layer to manufacture the keyboard.

3. The method for applying an in-mold decoration technology to manufacture a keyboard with more key height and less key spacing according to claim 1, wherein the plastic film is a polycarbonate resin film; the plastic material is a polycarbonate resin material; the elastic material layer is a rubber layer.

4. The method for applying an in-mold decoration technology to manufacture a keyboard with more key height and less key spacing according to claim 1, wherein the step (3) further includes coating an UV hardenable resin to the bottom base of a plurality of the protruding granules and integrating into the elastic material layer, and then curing the UV hardenable resin utilizing UV ray; Further, the elastic material layer is to integrate the protruding granules.

5. The method for applying an in-mold decoration technology to manufacture a keyboard with more key height and less key spacing according to claim 1, wherein the step (3) further includes applying a glutinous stuff to adhesive the elastic material layer and the protruding granule.

6. The method for applying an in-mold decoration technology to manufacture a keyboard with more key height and less key spacing according to claim 1, further includes a method for manufacturing the plastic film with a plurality of the protruding portions comprising the steps of:
(a) applying an in-mold decoration and ejaculation technology to manufacture a plastic film, the plastic film includes a plurality of protruding portions, and the gap between a plurality of the protruding portions has the first spacing;
(b) applying the plastic film placed into an ejaculation mold, and within the ejaculation mold, the plastic material is to fill the interior of the protruding portions of the plastic film.

7. The method for applying an in-mold decoration technology to manufacture a keyboard with more key height and less key spacing according to claim 6, wherein the step (b) further applying the plastic material which corresponds to each bottom base of the protruding portion to form a groove, and the step (b) which the elastic material layer includes corresponding protruding portions and the protruding portions fasten to the grooves respectively.

8. The method for applying an in-mold decoration technology to manufacture a keyboard with more key height and less key spacing according to claim 7 wherein the step (3) further includes coating an UV hardenable resin to the bottom base of a plurality of the protruding granules and integrating into the elastic material layer, and then curing the UV hardenable resin utilizing UV ray; Further, the elastic material layer is to integrate the protruding granules.

9. The method for applying an in-mold decoration technology to manufacture a keyboard with more key height and less key spacing according to claim 8, wherein the plastic film is a polycarbonate resin film, the plastic material is a polycarbonate resin material, and the elastic material layer is a rubber layer.

10. A keyboard being made by means of the method defined in claim 1 comprising: an elastic material layer to integrate a plurality of protruding granules, the surface of the plurality of protruding granules is plastic film; the interior of the plurality of protruding granules are filled with the plastic material.

11. The keyboard according to claim 10, wherein the plastic film is a polycarbonate resin film, the plastic material is a polycarbonate resin material, and the elastic material layer is a rubber layer.

12. The keyboard according to claim 11, wherein applying an UV hardenable resin to join the elastic material layer and the plurality of the protruding granules.
